(19) United States
(12) Patent Application Publication
(10) Pub. No.: US 2014/0075149 A1
(43) Pub. Date: Mar. 13, 2014

(54) Storage Mechanism with Variable Block Size

(71) Applicant: Robert Pike, Woodinville, WA (US)

(72) Inventor: Robert Pike, Woodinville, WA (US)

(73) Assignee: TRANSPARENT IO, INC., Woodinville, WA (US)

(21) Appl. No.: 13/612,968

(22) Filed: Sep. 13, 2012

(51) Int. Cl. G06F 12/10

(52) U.S. Cl. 711/206; 711/E12.061

(57) ABSTRACT

A file system may access a logical unit by addressing storage space using a constant block size, but the underlying logical unit may physically store information using different block sizes for different types of files. Certain file types may be stored using large blocks sizes for performance, while other file types may be stored using smaller block sizes for storage efficiency. A storage management system may create the logical unit from different block extents on various storage devices, where each block extent may be created with different block sizes. The system may place a file in a block extent that may be appropriate for the file type, and may perform a translation between the file system's request for a specific block and the manner in which the block is stored on the media.

### BACKGROUND

Storage systems are used to store data and various executable code for computer systems. In a typical storage system, blocks of storage are assigned by a file system, which may present files to an operating system or application. The file system may map blocks of data to individual files.

A block in a storage system may refer to the smallest unit of storage available. Systems that use large block size often have improved performance for large files, as the number of blocks that are processed for a large file is reduced. However, large block sizes can be inefficient for small files, as more wasted space may occur when a small file does not fill up an entire block. Similarly, small block sizes may give improved performance for instances with many small files but poorer performance with very large files.

### SUMMARY

A file system may access a logical unit by addressing storage space using a constant block size, but the underlying logical unit may physically store information using different block sizes for different types of files. Certain file types may be stored using large blocks sizes for performance, while other file types may be stored using smaller block sizes for storage efficiency. A storage management system may create the logical unit from different block extents on various storage devices, where each block extent may be created with different block sizes. The system may place a file in a block extent that may be appropriate for the file type, and may perform a translation between the file system's request for a specific block and the manner in which the block is stored on the media.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a computer system with a storage management system.

FIG. 2 is a diagram illustration of an embodiment showing a device with storage having different block extents.

FIG. 3 is a flowchart illustration of an embodiment showing a method for provisioning storage devices for a logical unit.

FIG. 4 is a flowchart illustration of an embodiment showing a method for configuring a logical unit for an image.

FIG. 5 is a flowchart illustration of an embodiment showing a method for processing a read request.

### DETAILED DESCRIPTION

A storage management system may store files in block extents that have different block sizes, yet may allow a file system to address the storage area using a single block size. The storage management system may create the logical unit from many devices, some of which may have different performance characteristics and may be available over different bus or network connections. Some of the block extents may be created with large block sizes, which may be appropriate for a certain class of files, while other block extents may be created with small block sizes, which may be appropriate for a different class of files.

After a storage management system determines which block extent to store or retrieve a file, a conversion may be performed from the block address used by a file system to the block address within the logical unit. For cases where the storage block size is larger than the file system block size, the storage management system may retrieve a large block, identify the requested block as a subset of the larger block, and present the requested block to the file system. The remainder of the larger block may be cached to quickly process a second file system request for the remainder of the larger block. In such a case, a single call may be made to the storage device for the large block to service multiple calls from the file system.

The storage management system may create a logical unit by building block extents with block sizes that match an image or a requested configuration. When an image exists, the image may be analyzed to identify the types of files and estimate the corresponding block extents that may use specific block sizes. When a logical unit may be created without an image file, a predefined configuration may be used to create several different block extents, each with a different block size. As the logical unit is populated with different files, the block extents may be populated and expanded in size.

The storage management system may use a service level agreement that correlates the file type with the block size for storing that file type. The service level agreement may identify specific characteristics of files and define that files with the defined characteristics are to be stored in block extents with specific block sizes.

A storage management system may present a single logical unit while providing the logical unit on a plurality of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may define certain parameters that may be applied to storage blocks having the same characteristics. Such a system may allow certain types of blocks to have different service level parameters than other blocks.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

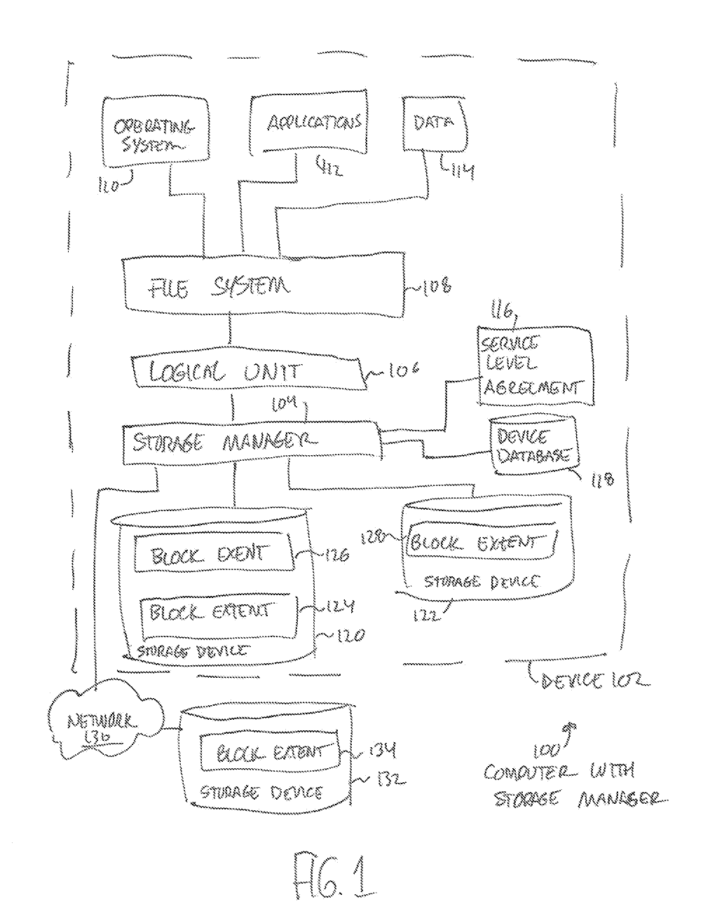

FIG. 1 is a diagram of an embodiment 100 showing a computer system 102 with a storage management system. Embodiment 100 illustrates a storage management system 104 that creates a logical unit 106 that a file system 108 may use to store and retrieve data.

The storage management system 104 may use multiple storage devices to create and manage the logical unit 106. The logical unit 106 may operate as a single storage device to the file system 108, and the file system 108 may interact with the logical unit 106 as if the logical unit 106 was a single disk drive or other storage mechanism.

The storage management system 104 may manage the logical unit 106 by placing blocks of data on various storage devices. The blocks of data may be presented to the file system 108 as a single storage device. In many embodiments, the file system 108 may not be aware that the logical unit 106 may not be composed of multiple storage devices.

The storage management system 104 may effectively map the address space of a logical unit 106 to multiple address spaces of various block extents. When the block extents have different block sizes, the mapping of the blocks presented by the logical unit 106 to the blocks used for storage may not be a 1:1 mapping. In some cases, the mapping may be one block in the logical unit to 2, 4, 8, or more blocks in a storage device's block extent. In other cases, the mapping may be one block in a storage device's block extent and 2, 4, 8, or more blocks in the logical unit.

The storage management system 104 may provide storage capabilities with different block sizes. For example, a single logical unit may be constructed with block extents that may be configured with different block sizes. Larger files may be stored in a block extent with a larger block size, while smaller files may be stored in block extents with smaller block size.

The storage management system 104 may manage the storage assigned to a logical unit and may reconfigure the storage accordingly. For example, a group of files may be assigned to a specific block extent with a specific block size. As the block extent becomes full, the storage management system 104 may assign an additional block extent with the same block size to the group of files.

The file system 108 may address the logical unit using a single block size yet some files may be physically stored on block extents with different block sizes. For example, a file system 108 may be created such that it may address all of the assigned storage using 512K blocks. The logical unit 106 may present 512 byte blocks to the file system 108, but the storage manager 104 may store one set of files in a block extent created with 4096 byte-sized blocks.

In an example of such a case, the storage manager 104 may receive a request for a single 512 byte block, retrieve the entire 4096 byte block, and extract the requested 512 byte block to transmit to the file system 108. The entire 4096 byte block may be cached so that a subsequent request for a second block within the retrieved 4096 byte block may be handled without having to fetch the block again. In this situation, the second request may be handled much faster than the original request.

In such embodiments, the storage manager 104 may apply a service level agreement 116 to individual files or groups of files. For example, a specific file or file directory may be designated to meet specific storage and retrieval performance standards. The storage manager 104 may determine that a service level agreement is not being met and may move the file or group of files to a different block extent with a different block size to meet the performance metric for the service level agreement.

In another example, a file or group of files may be designated to be a certain file type. The service level agreement 116 may determine that files of a certain type are to be stored with a specific block size. In such a case, the storage manager 104 may store those files in a block extent with a corresponding block size.

The file system 108 may manage files of data which may be accessed by an operating system 110 and various applications 112. The file system 108 may also store data 114 that may be accessed by the operating system 110 and applications 112.

A service level agreement 116 may define the performance metrics and other characteristics of the logical unit 106. The storage management system 104 may create the logical unit 106 according to the service level agreement 116, and then manage the logical unit 106 to meet the service level agreement 116 during operation.

Prior to creating the logical unit 106, the storage management system 104 may take an inventory of available storage devices and store descriptors of the storage devices in a device database 118. The inventory may include static descriptors of the various devices, including network address, physical location, available storage capacity, model number, interface type, and other descriptors.

The inventory may also include dynamic descriptors that define maximum and measured performance. The storage management system 104 may perform tests against a storage device to measure read and write performance, which may include latency, burst and saturated throughput, and other metrics. In some embodiments, the storage management system 104 may measure dynamic descriptors over time to determine when a service level agreement may not be met or to identify a change in a network or device configuration.

The storage management system 104 may manage many different types of devices to create and manage the logical unit 106. In the example of embodiment 100, storage devices 120 and 122 are illustrated as locally accessible devices. Storage device 120 may have two block extents 124 and 126, each of which may have different block sizes. Storage device 122 may have a block extent 128.

The storage manager 104 may also access various network connected storage devices. The illustration of embodiment 100 shows a network 130 where storage device 132 may be accessed with a block extent 134.

The storage manager 104 may configure all of the various block extents to create the logical unit 106 presented to the file system 108. The configuration may include creating the various block extents and formatting the block extents using a specific block size. In some embodiments, certain storage devices may be formatted with only a single block size. In such cases, block extents from the same device may have the same block size, and the storage manager 104 may use differently formatted devices to provide storage with different block sizes.

Each of the various types of devices may have different performance or other characteristics. For example, locally attached devices may have faster response times than network attached devices. Some devices may have a higher capital cost or a higher operating cost. In many cases, higher performance devices may come with an increased capital cost or energy consumption.

Some devices may different reliability characteristics. Spinning media, notably hard disk drives, may fail in a catastrophic fashion, while solid state storage media may tend to fail gradually.

In each case, the storage devices may store various blocks of data, as opposed to storing individual files. In some instances, a single file may have part of the file stored in a first group of blocks on a first device, while another part of the file may be stored in a second group of blocks on a second device.

The block level management of a logical unit may enable the storage management system 104 to treat each block of data separately. For example, some blocks of a logical unit 106 may be accessed frequently while other blocks may not. The frequently accessed blocks may be placed on a storage device that offers increased performance, such as a local flash memory device, while other blocks may be placed on a device that offers poorer performance but may be operated at a lower cost.

The storage management system 104 may create and manage a logical unit 106 to meet criteria defined in a service level agreement 116. The service level agreement 116 may define a size for the logical unit 106, number of replications of blocks of data, and various performance characteristics of the logical unit 106.

The size of a logical unit 106 may be defined using thin or thick provisioning. In a thick provisioned logical unit, all of the storage requested for the logical unit may be provisioned and assigned to the logical unit. In a thin provisioned logical unit, the maximum size of the logical unit may be defined, but the physical storage may not be assigned to the logical unit until requested.

In a thin provisioned logical unit, the storage management system 104 may assign additional blocks of storage to the logical unit 106 over time. When the amount of storage actually being used grows to be close to the physical storage assigned, the storage management system 104 may identify additional storage for the logical unit. The additional storage may be selected to comply with the storage level agreement 116.

The number of replications of blocks of data may define how many different devices may store each block, as well as what type of devices. The replications may be used for fault tolerance as well as for performance characteristics.

Replications may be defined for fault tolerance by selecting a number of devices that store a block so that if one of the devices were to fail, the block may be retrieved from one of the remaining devices. In some embodiments, a replication policy may define that a local copy and a remote copy may be kept for each block. Such a policy may ensure that if the local device were compromised or failed, that the data may be recreated from the remote storage devices. In some policies, such remote devices may be defined to be another device within the same or different rack in a datacenter, for example. In some cases, a replication policy may define that an off premises storage device be included in the replication.

The replications may define whether a write operation may be performed in a synchronous or asynchronous manner. In an asynchronous write operation, the write operation may complete on one device, then the storage management system 104 may propagate the write operations to another device. When an off premises or other remote storage is used, some replication policies may permit the remote storage to be updated asynchronously, while writing synchronously to multiple local devices.

Replications may be defined for performance by selecting multiple devices that may support striping. Striping read operations may involve reading from multiple devices simultaneously, where each read operation may read a different block or different areas of a single block. As all of the data are read, the various portions of data may be concatenated and transmitted to the file system 108. Striping may increase read performance by a factor of the number of devices allocated to the striping operation.

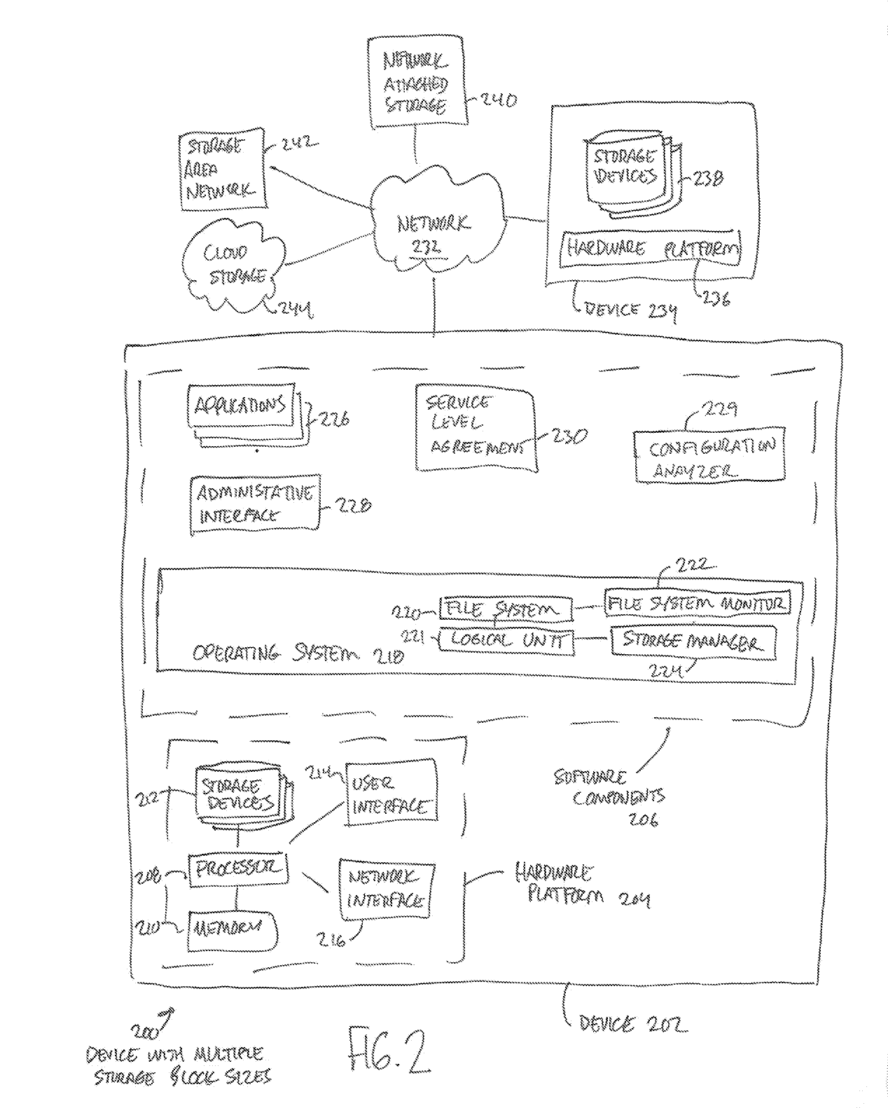

FIG. 2 is a diagram of an embodiment 200 showing a computer system with a storage management system that may store files using different sized storage blocks. The storage management system may create and manage a logical unit for storage accessible by an operating system and applications, where the storage blocks may be managed independently of files or other storage constructs. Policies may be implemented on a file system level but the management of storage media may occur at a block level.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may illustrate an example of a device that may have a managed logical unit that may operate with storage blocks. An operating system's file system may recognize the logical unit as a storage unit in the same way as a conventional disk drive may be treated as a storage unit.

The file system may address a logical unit using a constant block size, however, a storage management system may store the files using file extents with different block sizes. The storage management system may place files in different block extents based on a service level agreement as applied to the files. The different block sizes may affect access times, storage efficiency, and other factors that may or may not be defined in a service level agreement.

A file system monitor may identify and tag storage blocks with characteristics of the files to which the blocks belong. Once the blocks are tagged, the storage system may apply different policies defined in a service level agreement to those blocks.

The storage management system may use a service level agreement to define how each storage block may be managed. The service level agreement may define various redundancy criteria, performance metrics, or other parameters for the logical unit. The storage management system may attempt to meet the service level agreement in the initial configuration of a logical unit, as well as make changes to the storage system to meet the service level agreement during operations.

Block size for storing files may be one factor that a storage management system may use to meet a service level agreement. Larger files and files that are accessed sequentially may see a performance benefit when stored in larger block sizes, while smaller files and files that are accessed randomly may benefit from smaller block sizes.

Embodiment 200 illustrates a device 202 that may have a hardware platform 204 and various software components 206. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 that may have a file system 220 that interacts with a logical unit 221 provided by a storage management system 224. A file system monitor 222 may detect, classify, and tag each storage block managed by the storage manager 224. The operating system 218 may provide an abstraction layer between the hardware platform 204 and various software components, which may include applications, services, and various kernel and user level software components.

The file system 220 may create and manage files that may be accessed by the operating system 218 as well as various applications 226. The file system 220 may create files, apply permissions and various access controls to the files, and manage the files as distinct groups of storage.

The logical unit 221 may store the files in blocks of storage that may be allocated to the files. As files grow, additional blocks within the logical unit 221 may be assigned to the files.

The storage management system 222 may create and manage the storage according to a service level agreement 230.

A file system monitor 222 may detect all file system changes and may tag each block of data that may be created or changed with information that may enable the storage manager 224 to apply the service level agreement 230.

An administrative user interface 228 may have a user interface through which a system administrator may configure and manage the storage management system. The user interface may allow the administrator to define a logical unit 221 and set the parameters by which the logical unit 221 may be operated, which may include defining and editing a service level agreement 230. In some cases, the user interface may also allow the user to view the current and historical performance of the logical unit 221.

A configuration analyzer 229 may populate and update a database of available storage devices. The configuration analyzer 229 may discover all available storage devices and determine static and dynamic capacities of those devices. A static capacity may include currently available storage, physical location, network or local address, device type, and other parameters. Dynamic capacities may include various performance metrics that may be tested, measured, and monitored during operation. Such metrics may be burst and sustained bandwidth, latency, and other parameters.

The configuration analyzer 229 may monitor the storage devices over time. In some cases, the performance, capacity, or other parameters may change, which may trigger the storage management system 224 to make changes to the logical unit 221 in order to meet the service level agreement 230.

In some embodiments, the various storage management system components may communicate over a network 232 to access and manage various remote storage systems. A remote storage system may be a device 234 that has a hardware platform 236 on which various storage devices 238 may be made available. In some cases, the storage devices 238 may be iSCSI or other devices that may be accessed over a network 232. The remote storage systems may include network attached storage 240, storage area networks 242, cloud storage 244, and other storage devices that may be accessed over the network 232. In some cases, a service level agreement 230 may define that some or all of the blocks of data in the logical unit be stored on remote storage devices.

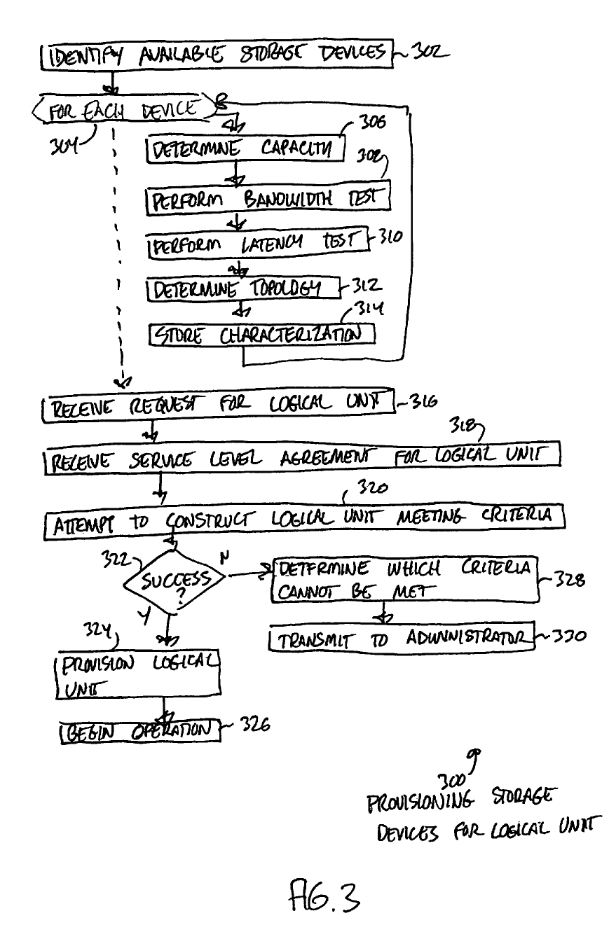

FIG. 3 is a flowchart illustration of an embodiment 300 showing a method for provisioning storage devices for a logical unit. Embodiment 300 illustrates one method by which a service level agreement may be used to configure and deploy a logical unit after gathering metadata about the available storage devices.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, all of the available storage devices may be identified. In some embodiments, a crawler or other automated component may detect and identify local and remotely attached storage devices. In some embodiments, a user may identify various storage devices to the system. Such embodiments may be useful when remotely available storage devices may not be readily accessible or identifiable to a crawler mechanism.

For each device in block 304, the capacity may be determined in block 306. The capacity may include the amount of raw storage that may be available on the device.

A bandwidth test may be performed in block 308 to determine the burst and sustained rate of data transfer to and from the device. Similarly, a latency test may be performed in block 310 to determine any initial or sustained latency in communication with the storage device. In some embodiments, the bandwidth and latency tests may be a dynamic performance test, where the communication to the device may be exercised. In some embodiments, the bandwidth and latency may be determined by determining the type of interface to the device and deriving expected performance parameters.

A dynamic performance test may be useful when a storage device may be accessed through a network or other connection. In such cases, the network connections may add performance barriers that may not be determinable through a static analysis of the connections.

The topology of the device may be determined in block 312. The topology may define the connections from a logic unit to the storage device. The topology may include whether or not the device may be local to the intended computing device. For remotely located devices, the topology may include whether the device is in the same or different rack, the same or different local area network, the same or different datacenter or other geographic location.

In many embodiments, a service level agreement may enforce a duplication parameter where duplicates of each block may be stored in various remote locations. For example, a service level agreement may define that a copy of all blocks be stored in a datacenter within a specific country but remote from the device accessing the logical unit.

The topology may also define the block sizes possible for each device. In some devices, the block size may be determined when the device is initially formatted and may not be changed thereafter. Other devices may have unformatted portions of storage that a storage manager may subsequently format using a specific block size.

After determining the topology and other metadata about the storage devices, the characterization of the storage devices may be stored in block 314.

A request for a logical unit may be received in block 316. The service level agreement may be received in block 318 for the logical unit.

In block 320, an attempt to construct a logical unit may be made according to the service level agreement. The logical unit may be constructed by first identifying storage devices that may meet the performance metrics defined in a service level agreement. In some cases, the performance metrics may be met by combining two or more storage devices together, such as striping devices to increase read performance.

Once the performance metrics may be met, the storage capacity of a logical unit may be attempted to be met by provisioning the storage devices. In some cases, the provisioning may be thin provisioning, where the full physical storage capacity may not be assigned or provisioned, and where the full physical storage capacity may or may not be available at the time the storage is provisioned.

The provisioning exercise in block 320 may include provisioning specific storage devices with specific block sizes for storage.

If the storage management system has determined that a logical unit may be provisioned with success in block 322, the logical unit may be provisioned in block 324 and may begin operation in block 326.

If the storage management system determines that the service level agreement may not be met in block 322 to result in a successful provisioning, the criteria that may not be met may be determined in block 328. These criteria may be presented to an administrator in block 330, and the administrator may elect to change the criteria or make other changes to the system to meet the criteria. In some cases, the administrator may add more storage devices to the available storage devices to meet the deficiencies identified in block 328.

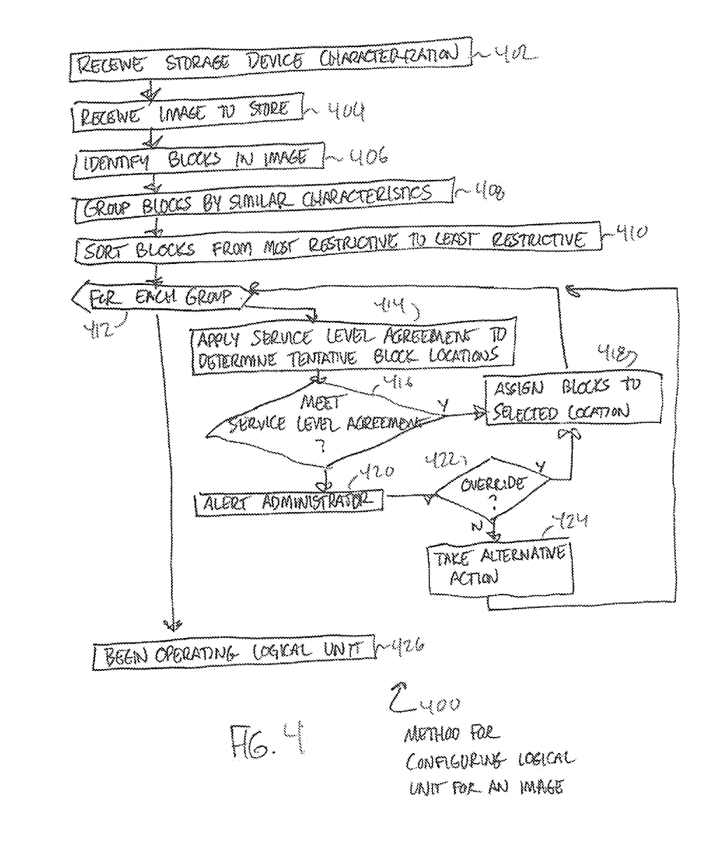

FIG. 4 is a flowchart illustration of an embodiment 400 showing a method for configuring a logical unit for a given image. Embodiment 400 illustrates one method by which blocks in an image may be examined and placed on a set of available storage devices to best meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The characterizations of available storage devices may be received in block 402. The characterizations may define the capabilities, performance, and other parameters about the available storage devices.

An image may be received in block 404. An image may include all of the blocks for a logical unit, which may be identified in block 406. The image may contain blocks with different tags that define how the block may be classified and used.

The blocks may be grouped in block 408 by similar characteristics, and sorted in block 410 from the most restrictive to the least restrictive. Each group of blocks may be processed in block 412.

For each group of blocks in block 412, a service level agreement may be applied to identify tentative locations for the block. The service level agreement may define the desired block size for storage, along with performance, number of copies of blocks, and other parameters. In many cases, the service level agreement may define one set of parameters for one type of block and another set of parameters for another type of block. As such, each group of blocks may be treated differently by the service level agreement.

If the tentative placement of the blocks meets the service level agreement in block 416, the blocks may be assigned to the selected location in block 418. If the service level agreement is not met in block 416, an administrator may be alerted in block 420. The administrator may elect to override the service level agreement in block 422, in which case the blocks may be placed according to the selected location in block 418. Otherwise, the administrator may take alternative action in block 424, which may be to add more storage devices, change the placement of the logical unit, or other action.

Once each group is placed on the storage devices, the logical unit may begin operation in block 426.

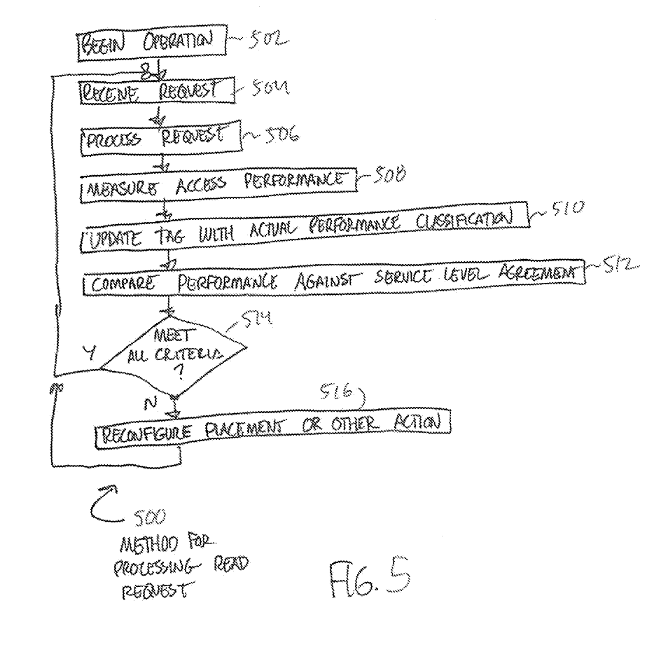

FIG. 5 is a flowchart illustration of an embodiment 500 showing a method for operating a logical unit and specifically processing a read request. Embodiment 500 illustrates how the service level agreement may be used to identify storage blocks that may be reconfigured to meet a service level agreement.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A logical unit may begin operation in block 502. As part of normal operation, the logical unit may receive a request, which may be a read request, in block 504. The request may be processed in block 506.

During the operation, a storage manager may measure access performance of the system in block 508. The tags for any blocks processed by the system may be updated in block 510 with an actual or measured performance classification.

The actual or measured performance may be compared against the service level agreement in block 512. If the service level agreement is met in block 514, the process may return to block 504 to process additional requests. If the service level agreement is not met in block 514, the blocks may be reconfigured in block 516 or other action may be taken.

The reconfiguration in block 516 may move blocks from one storage device to another device that may have increased or decreased performance. In some instances, the reconfiguration may be to move blocks from one block extent to another block extent. When the block extents have different block sizes, the system may convert from one block size to another for storage.

For example, a block that may be accessed infrequently may be moved to a slower performing storage device, while a block that may be accessed very frequently may be moved to a higher performing storage device.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a read request for a first block from a file system, said request comprising an first address for said first block, said file system having an addressing scheme comprising a first block size, said first block size being applied to all blocks within a logical unit;
determining where said first block is stored within said logical unit, said logical unit comprising a plurality of block extents, a first block extent being addressed using a second block size;
mapping said first block address to a second address, said second address being a pointer within said first block extent;
retrieving said first block from said first block extent; and
presenting said first block to said file system.

2. The method of claim 1, said first block size being larger than said second block size.

3. The method of claim 2 further comprising:
retrieving a plurality of blocks from said first block extent; and
combining said plurality of blocks into said first block.

4. The method of claim 1, said first block size being smaller than said second block size.

5. The method of claim 1 further comprising:
retrieving a second block from said first block extent; and
extracting said first block from said second block.

6. The method of claim 1 further comprising:
receiving a file create request from a file system, said file create request creating a first file;
identifying metadata for said file system from which to select said first block extent for creating said first file;
receiving a second block having said first block size for said first file;
translating said first block size to said second block size; and
storing said first block using said second block size on said first file extent.

7. The method of claim 6, said first block size being smaller than said second block size.

8. The method of claim 6, said first block size being larger than said second block size.

9. The method of claim 6, said metadata defining a file type.

10. The method of claim 6, said metadata defining a file directory in which said first file resides.

11. The method of claim 1, said first block extent being located on a first storage device.

12. The method of claim 11, said first storage device comprising a second block extent having a third block size, said second block extent being part of said logical unit.

13. The method of claim 1 further comprising:
identifying a plurality of block sizes for said logical unit;
creating a plurality of block extents, each of said block extents having a block size;
creating said logical unit from said plurality of block extents; and
presenting said logical unit to said file system.

14. The method of claim 13, at least two of said block extents being on different devices.

15. The method of claim 14, at least two of said block extents being on a first device.

16. A system comprising:
a plurality of storage devices;
a storage manager that:
presents a logical unit to a file system, said logical unit having a first block size and being addressable by said file system using said first block size;
receives a read request for a first block from said file system, said request comprising an first address for said first block;
determines where said first block is stored within said logical unit;
maps said first block address to a second address, said second address being a pointer within said first block extent;
retrieves said first block from said first block extent located on a first storage device; and
presents said first block to said file system.

17. The system of claim 16, said storage manager that further:
identifies a plurality of block sizes for said logical unit;
creates a plurality of block extents, each of said block extents having a block size;
creates said logical unit from said plurality of block extents; and
presents said logical unit to said file system.

18. The system of claim 17, said first block extent having block size larger than said first block size.

19. The system of claim 17, said first block extent having block size smaller than said first block size.

20. The system of claim 19, said first block being assembled from a plurality of blocks retrieved from said first block extent.
